(19) United States
(12) Patent Application Publication
(10) Pub. No.: US 2004/0050767 A1
(43) Pub. Date: Mar. 18, 2004

(54) Retaining ring cap filter

(76) Inventors: Patrick S. O'Hern, Tulsa, OK (US); Larry T. Cole, Jenks, OK (US)

Correspondence Address: CHRISTOPHER H HUNTER, PARKER-HANNIFIN CORPORATION, 6035 PARKLAND BOULEVARD, CLEVELAND, OH, 44124-4141, US

(21) Appl. No.: 10/648,021

(22) Filed: Aug. 26, 2003

Related U.S. Application Data
(60) Provisional application No. 60/410,681, filed on Sep. 13, 2002.

(51) Int. Cl. B01D 27/00

(52) U.S. Cl. 210/232; 210/457

(57) ABSTRACT

A filter assembly including a filter element retained within the central core of the element with a C-shaped retaining ring. The retaining ring is located in an internal annular groove in one end cap. The other end of the support core is supported against the opposite end cap, or an additional retaining ring can be provided. When the element is spent, the element is removed from the housing, the retaining ring and central support core are removed, and the element is disposed of in an appropriate manner (preferably by crushing and incineration). The support core is then inserted into a replacement/fresh element and held in place by the ring.

### CROSS-REFERENCE TO RELATED CASES

The present application claims the benefit of the filing date of U.S. Provisional Application Serial No. 60/410,681; filed Sep. 13, 2002, the disclosure of which is expressly incorporated herein by reference.

### FIELD OF THE INVENTION

The present invention relates generally to fluid filters, and replaceable elements therefor.

### BACKGROUND OF THE INVENTION

Many fluid filters have filter media formed into an elongated ring, circumscribing a central axis and defining an internal, cylindrical cavity. End caps are sealing bonded to opposite ends of the ring, with, e.g., a potting compound. In some applications, one of the end caps is a disk-like piece, that is, it is completely closed across its extent; while the other end cap has an annular configuration. In other applications, both end caps have an annular configuration.

The filter element is located in a housing such that a flow path is created through the media, radially-inward or radially-outward, from an upstream “dirty” side to a downstream “clean” side of the element. In the first structure indicated above, that is, where one end is completely closed, the open end of the element will typically be sealed against an inlet or outlet port, which may extend centrally within the element. In the other structure, where both ends are open, both end caps will be sealed against the port, which again, may extend centrally within the element. In either case, the end cap(s) fluidly separate the inlet, dirty flow stream from the outlet, clean flow stream.

In some applications, the flow through the element is of such a pressure that the element requires additional support. This is sometimes accomplished with a central, perforated support core, formed from, e.g., metal or rigid plastic, extending the length of the element and closely received within the internal cavity. A central support core is particularly useful when the flow is outside-in, as the pressure around the exterior of the element can crush or deform the element during use. Some support cores are attached (permanently, or at least securely) to a closed end of the filter housing, and extend a short distance axially toward the opposite, open end of the housing. U.S. Pat. No. 5,443,721, for example, shows such a support core. The element is simply inserted through the open end of the housing, slid down over the central support core, and an end cap or cover is (typically removeably) attached to the open end of the housing to enclose the element. Such a filter assembly is desirable as the element can be formed from material that is incineratable (“green”), and since the reusable portion of the element (i.e., the support core) remains with the housing, the element can be removed from the core when spent and easily disposed of, thereby reducing or eliminating the material sent to landfills, and with some filter materials, even providing an energy source.

Some filter housings do not include a rigid and permanently-attached support core; rather, the support core is provided integral with the filter element. The support core in these elements is permanently attached to one or both ends of the media and/or the end caps. U.S. Pat. No. 2,550,070 shows an example of this type of element. While this type of element also has the necessary internal support for high-pressure use, it can be difficult and/or expensive to manufacture a suitable support core from an incineratable material. It can also be costly and time-consuming to form the media around the support core, and to attach the support core to the ends of the media and/or the end caps. Having a support core integral with each replacement element also increases the material costs of the element, and therefore the costs associated with the installation and maintenance of the filtration system.

Thus, it is believed that in applications which do not include a rigid, permanent support core integral with the filter housing, there is a demand for a filter assembly including a filter element which includes a support core which can be easily removed from the element prior to disposal, and where the support core can then be re-used with a replacement/fresh element, to thereby reduce the material costs of the system and also the material which must be incinerated or otherwise disposed of when the element is spent.

### SUMMARY OF THE PRESENT INVENTION

The present invention thereby provides a filter assembly including a filter element which has a central support core which provides support for the element during use, and which can be easily removed from the element when the element becomes spent. The support core can then be used with a fresh element, so as to reduce the material necessary to be disposed of when the element needs to be changed, and to reduce the material and assembly costs of the element, and of the filtration system in general.

According to the present invention, the support core is retained and supported within the central core of the element by a retaining ring. Preferably the retaining ring is a simple C-ring, located in an internal annular groove in one end cap and projecting slightly radially inward into the internal cavity of the element. The retaining ring engages one end of the support core, while the other end of the support core is supported by the opposite end cap in the element, or by a similar retaining ring/groove combination in the other end cap.

When the element is spent, the element is removed from the housing, the retaining ring is removed, and the central support core is removed from the element. The element can then be disposed of in an appropriate manner, preferably by crushing and incineration. The support core is then inserted into a replacement/fresh element, and the ring is reinserted into a groove in the new element to retain the support core.

Thus, the present invention provides a filter assembly including a filter element which has a central support core which provides support for the element during use, but which can be easily removed from the element when the element becomes spent. The support core can then be used with a fresh element, so as to reduce the material necessary to be disposed of when the element needs to be changed, and to reduce the material and assembly costs of the element and of the system.

Further features of the present invention will become apparent to those skilled in the art upon reviewing the following specification and attached drawings.

### BRIEF DESCRIPTION OF THE DRAWINGS

FIG. 1 is a side view of a filter assembly, shown in partial cross-section, constructed according to the principles of the present invention;

FIG. 2 is a side view, also shown in partial cross-section, of the filter element, retaining ring and support core subassembly for the filter assembly of FIG. 1;

FIG. 3 is a side view, in partial cross-section, of the subassembly shown exploded;

FIG. 4 is an enlarged, cross-sectional side view of a portion of the subassembly of FIG. 2;

FIG. 5 is an enlarged, cross-sectional side view of a portion of one end cap for the filter element;

FIG. 6 is an end view of the filter subassembly, taken substantially along the plane described by the lines 6-6 of FIG. 2; and

FIG. 7 is a plan view of a retaining ring for the filter subassembly of FIG. 2.

### DETAILED DESCRIPTION OF THE PREFERRED EMBODIMENT

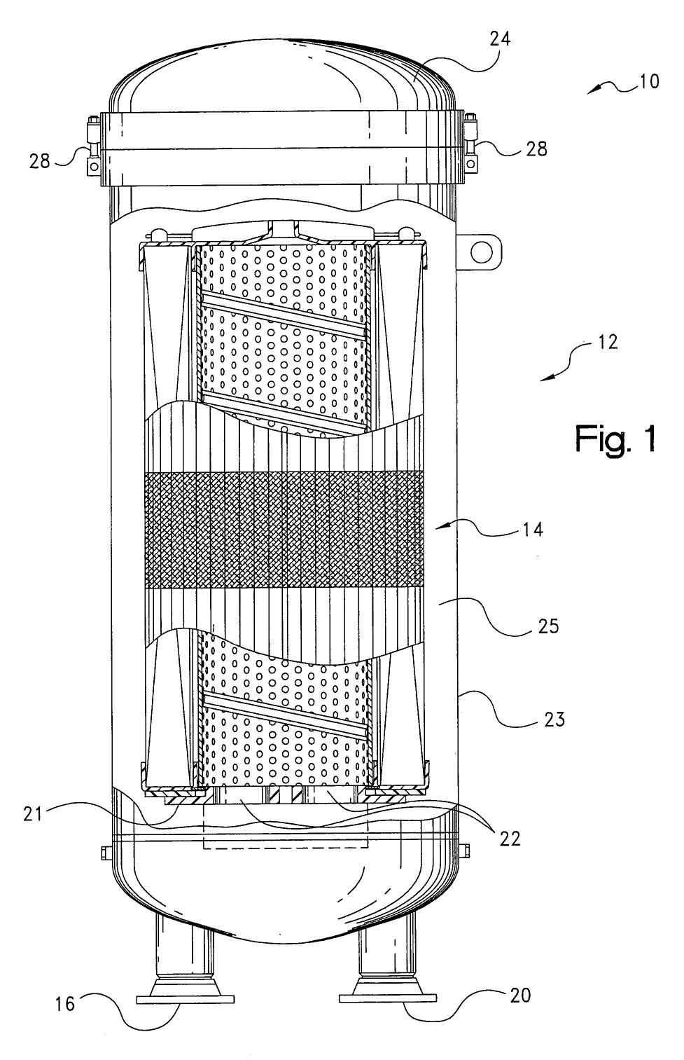

Referring to the drawings and initially to FIG. 1, a filter assembly constructed according to the principles of the present invention is indicated generally at 10. The filter assembly 10 includes a housing, indicated generally at 12, enclosing a filter element, indicated generally at 14. The housing 12 includes an inlet port 16 to direct fluid to be filtered (dirty fluid) into the assembly; and an outlet port 20 to direct filtered fluid (clean fluid) from the assembly. An annular base or adapter 21 with flow passages as at 22 extends centrally within the housing, and is fluidly connected at one end to outlet port 20.

The housing 12 can take any configuration appropriate for the particular application, and is illustrated as having a main body 23 and a cover or cap 24, which together form an enclosed chamber 25 for the element. Cap 24 can be attached to body 23 in any appropriate manner, and it is preferred that it be removeably attached, such as with fasteners as at 28. Appropriate fittings/nipples can be provided at the inlet and outlet ports, and the fluid directed through inlet port 16 passes around and inwardly through element 14, where particulate and other contaminants are removed, then passes through passages 22 in base 21 to outlet 20.

It is noted that the element is primarily described as being a “radially-in” element, that is, with the fluid flow radially inward through the media; but it is noted that the ports could be reversed, that is, with port 20 being the inlet port and port 16 being the outlet port, and the element could be used as a “radially-out” element with the fluid flowing radially outward through the media. In any case, the filter assembly of the present invention is useful with a variety of fluids to be filtered, as should be apparent to those skilled in the art.

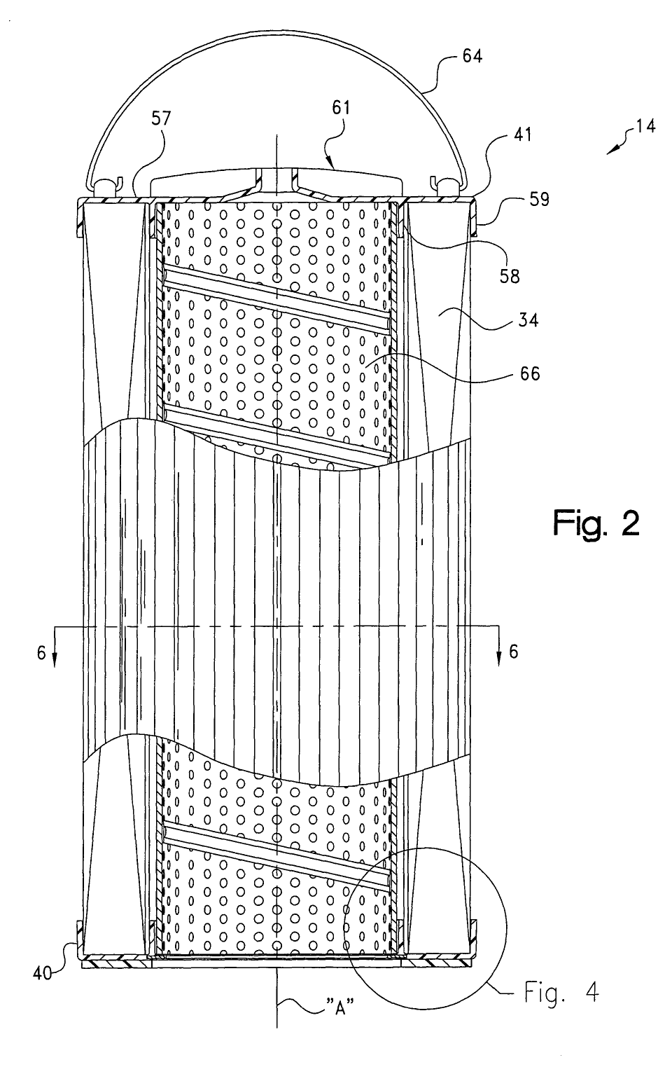

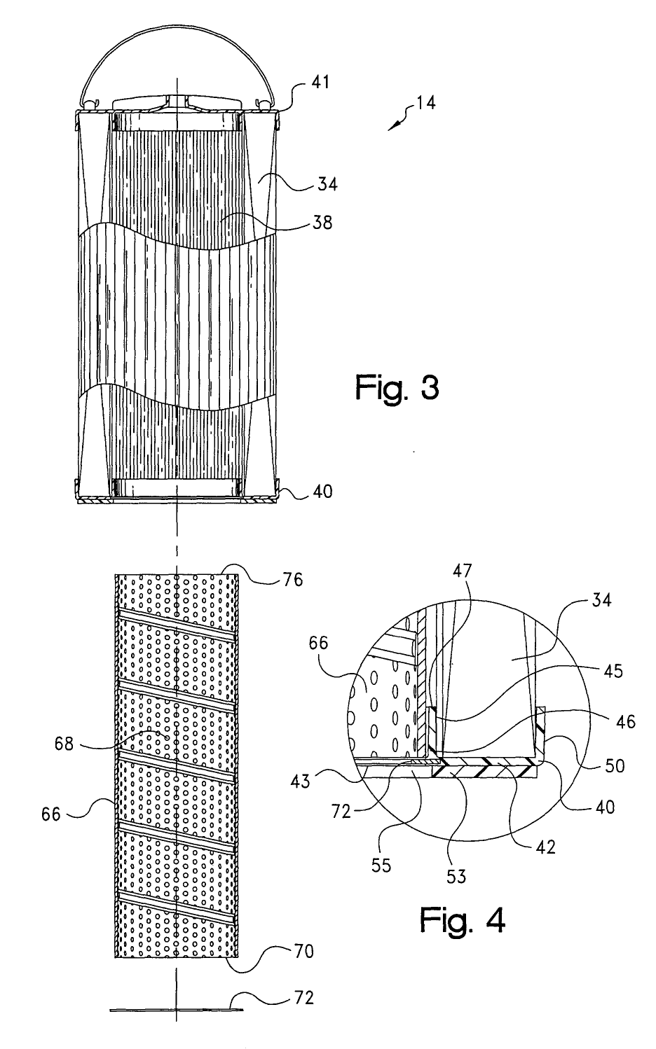

Referring now to FIGS. 2 and 3, the filter element 14 includes a ring of filtration media 34 circumscribing a central axis “A”, and defining an internal cylindrical cavity 38. Media ring 34 can be any media appropriate for the particular application, such as cotton, paper, cellulose, glass fiber, etc., and can be in any particular structure that is appropriate for the application, such as single layer, multi-layer, depth, pleated, non-pleated, etc.

End caps 40, 41, are sealingly bonded to each end of the media ring in an appropriate manner, for example with a potting compound. The end caps are also preferably formed from a material appropriate for the particular application, for example, plastic. Again, the present invention is particularly useful for media and end caps that are formed from incineratable material, so that a spent element can be crushed and incinerated to reduce or eliminate landfill space for the element.

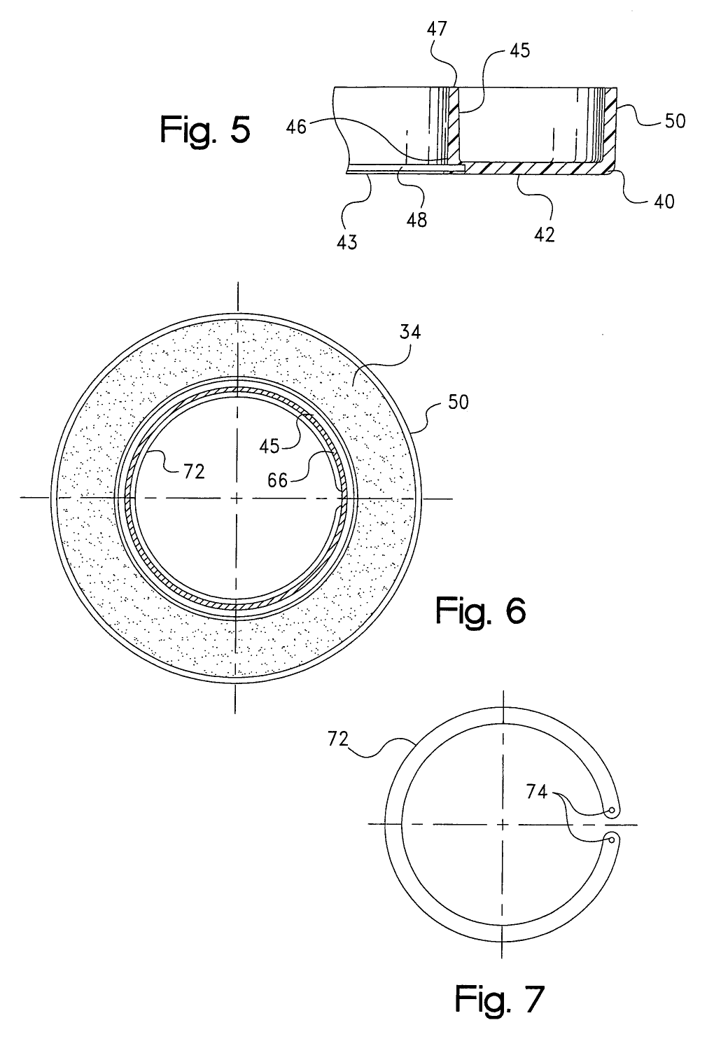

As shown in FIGS. 4 and 5, one end cap 40 has a flat, annular body 42 defining a central aperture 43, and an annular flange 45 inwardly bounding the aperture 43 and extending axially from an end 46 connected to the body 42 toward the opposite end cap 41. Flange 45 closely bounds the inner diameter of the media ring 34, and extends a relatively short distance, terminating at a distal end 47 located closer to the one end cap 40 than the other end cap 41.

An annular groove 48 (FIG. 5) is formed circumferentially around the inner diameter of end cap 40. The groove is illustrated as being formed in the inner diameter of flange 45, preferably as close as possible toward the open end of the filter element, although it could be formed along the axial extent of flange 45. Groove 48 opens radially inward, toward the central axis “A” of the element, and preferably has a rectangular configuration (i.e., parallel sidewalls and a perpendicular inner end wall) in cross-section, and a relatively thin opening, which is shown having a width less than the thickness of annular body 42. The dimensions and reasons for annular groove 48 will be more fully described below.

The end cap 40 further has an annular flange 50 that likewise outwardly bounds the media and extends a short distance axially along the outer diameter thereof, and terminates closer to end cap 40 than end cap 41. The various elements of end cap 40 are preferably formed together in one-piece, i.e., unitary.

An annular washer 53 is provide against the outer, flat surface of end cap 40, and secured thereto in any appropriate manner, such as with adhesive. Washer 53 facilitates seating and sealing the end cap 40 within the housing 12, and has a central opening 55 preferably as least as large as opening 43 in end cap 40.

The opposite end cap 41 for the element is similar to end cap 40, and as shown in FIG. 2, includes a flat, circular or disk-shaped body 57 which is continuous and extends across the entire extent of the media ring. The end cap 41 also includes short annular flanges 58, 59, which inwardly and outwardly bound the media ring 34, in the same manner as flanges 45 and 50 of end cap 40. End cap 41 further preferably includes a fin or ridge structure, indicated generally at 61, projecting axially away from an outer surface of the end cap, and which is designed to contact the inside surface of the cap 24, when the element is inserted into the housing. The various elements of end cap 41 are also preferably formed together in one piece, i.e., unitary.

A handle 64 is also attached to end cap 41, to facilitate lifting and carrying the element to avoid contact with fluid-soaked media.

While end cap 41 is shown with a disc-like configuration, it is to be noted that cap 41 could likewise have an annular configuration, similar to end cap 40, depending upon the particular application.

Referring now to FIGS. 2-4 and 6, a central support core 66 is received within the internal cavity 38 of the media ring 34 to provide radial support for the media. Core 66 is shown having an annular configuration, dimensioned to be closely, but easily received through aperture 43 in end cap 40, and is formed from a relatively rigid, strong material, such as metal or hard plastic. The core has perforations or openings, as at 68, to allow fluid flow therethrough, and has an axial length shorter than the length of the element 34, that is, the core is completely received in the element when inserted therein. The core is illustrated as being formed from a thin, perforated sheet metal, rolled in helical or spiral strips and welded, bonded or formed along its edges so as to form an integral, tubular structure; although it is noted that the core could be formed in a variety of conventional manners, as should be known to those skilled in the art.

The core 66 is retained and supported in the element so that the core remains with the element during use and when the element is initially removed from the housing; and can be removed from the element when the element is spent, and inserted into a replacement/fresh element for support thereof. To this end, one end (the illustrated lower end) 70 of the core is retained by a retaining ring 72, which is removable fixed to end cap 40. The retaining ring is flat, and as shown in FIG. 7, has a thin, C-shaped configuration which resiliently deflects to allow the retaining ring to be manipulated (e.g., pinched) to temporarily reduce the diameter of the ring such that the ring fits past the walls of aperture 48 and can be located in the groove. Once the retaining ring is inserted into the central aperture of the end cap 40, the ring can be allowed to expand to its normal diameter in groove 48.

The ring is preferably a metal, such as steel, but it could likewise be a hard plastic or other material compatible with the fluid to be filtered, depending upon the particular application. The ring has an outer diameter corresponding generally to the outer diameter of groove 48 in end cap 40, and a thickness which also generally corresponds to the width of the groove. The outer diameter and width of the groove, and corresponding width and thickness of the ring, are chosen so as to allow the ring to be easily manipulated and located in the groove, and removed therefrom, while providing sufficient support for the ring during use so that the ring does not deform or bend while supporting the end of the support core.

As can be seen in FIGS. 4 and 6, after the retaining ring 72 is inserted into the groove 48, the plane of the ring is substantially normal to the axis of the element, and the ring projects somewhat radially inward a short distance into aperture 43 of end cap 40, that is, slightly into the central cavity of the element, to directly engage the end 70 of the support core. The ring preferably projects radially inward slightly more than the inner diameter of the support core.

To facilitate inserting the ring 72 into the groove, and removing the ring therefrom, a pair of openings 74 can be formed on the opposing distal ends of the C-ring, to allow a tool to access and reduce the diameter of the ring. As indicated above, when the retaining ring 72 is removed from the element, the support core 66 can be removed from the element by sliding the core out through aperture 43 in end cap 40.

While a C-shaped retaining ring is preferred as a simple retaining means for the element, it is expected that other retaining devices could alternatively be used in conjunction with end cap 40 to retain the end of the support core in the element. For example, a continuous O-shaped ring could be used that would have sufficient flexibility to allow the ring to be deformed and inserted into the groove and hold the support core in the same manner as the C-shaped ring. Other devices are also possible, as long as the device directly or indirectly supports one end of the support core in the element, and can be manipulated in some manner to allow the core to be removed when the element is spent.

The other, opposite end (illustrated upper end) 76 of the support core 66 is preferably supported and retained in the element by direct engagement with the inside surface of the opposite end cap 41. Alternatively, if the opposite end cap is open, that is, if the opposite end cap 41 has an annular configuration similar to end cap 40, a combination groove/retaining device can likewise be used at that end, to allow the support core to be removed form either end when the element is to be replaced.

While it should be apparent from the above, once the element is spent, the element is removed from the housing 12, the retaining ring 72 is removed and the central support core 66 is removed from the element. The element can then be disposed of in an appropriate manner, preferably by crushing and incineration. The support core 66 is then inserted into a replacement/fresh element, and the ring 72 is reinserted into a groove in the new element to retain the support core.

Thus, as described above, the present invention provides a filter assembly including a filter element which has a central support core which provides support for the element during use, but which can be easily removed from the element when the element becomes spent. The support core can then be used with a fresh element, so as to reduce the material necessary to be disposed of when the element needs to be changed, and to reduce the material and assembly costs of the element and of the system.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

What is claimed is:

1. A filter element, comprising:
a ring of filtration media circumscribing a central axis and defining an internal cavity, an end cap sealingly bonded to each end of the media ring, with one of the end caps having an annular body defining a central aperture, and a groove formed circumferentially around an inner wall surface of the aperture, and opening radially inward toward the central axis of the element, wherein a central, perforated support core can be received internally of the element and retained therein by a retaining device received in the groove.

2. The filter element as in claim 1, wherein an annular flange inwardly bounds the opening of the body, and projects from an end connected to the body a short distance axially within the cavity toward the other end cap to a distal end located closer to the one end cap than the other, the groove formed in the flange toward the connected end of the flange.

3. The filter element as in claim 2, wherein the annular flange and annular body are formed unitary, in one piece.

4. The filter element as in claim 1, wherein all components of the filter element are formed from incineratable material.

5. The filter element as in claim 1, wherein the groove has a thin, substantially rectangular configuration in cross-section.

6. The filter element as in claim 5, wherein the width of the groove is less than the thickness of the one end cap.

7. A filter subassembly, including a ring of filtration media circumscribing a central axis and defining an internal cavity, an end cap sealingly bonded to each end of the media ring, with one of the end caps having an annular body defining a central aperture; and a retaining ring removeably attached to the one end cap and projecting radially inward into the internal cavity.

8. The filter subassembly as in claim 7, wherein a groove is formed circumferentially around an inner wall surface of the aperture in the one end cap, and opens radially inward toward the central axis of the element, and the retaining ring is received in the groove.

9. The filter subassembly as in claim 8, wherein the one end cap includes an annular flange inwardly bounding the annulus of the one end cap, and projecting from an end connected to the body a short distance axially within the cavity toward the other end cap to a distal end located closer to the one end cap than the other, the groove formed in the flange toward the connected end of the flange.

10. The filter subassembly as in claim 9, wherein the annular flange and annular body are formed unitary, in one piece.

11. The filter subassembly as in claim 7, wherein the retaining ring is a C-ring.

12. The filter subassembly as in claim 7, wherein all components of the filter element are formed from incineratable material.

13. The filter subassembly as in claim 7, and further including a central support core located within the central cavity and retained therein by the retaining ring.

14. The filter subassembly as in claim 13, wherein the support core is closely and completely received within the internal cavity of the filter media ring, and is supported at either end by the end caps of the element.

15. The filter subassembly as in claim 14, wherein the retaining ring is located so as to engage and support an axial end of the support core.

16. The filter subassembly as in claim 15, wherein the support core is retained at other axial end by the other end cap.

17. The filter subassembly as in claim 13, wherein all components of the filter element are an incineratable material, and the support core is metal.

18. A filter assembly including a housing; a filter element located in the housing and having a ring of filtration media circumscribing a central axis and defining an internal cavity; a support core removeably disposed within the internal cavity of the filtration media; and a retaining device removeably attached to the element and retaining the support core within the internal cavity, the retaining device being removable from the element to allow removal of the support core from the element.

19. The filter assembly as in claim 18, wherein an end cap is sealingly bonded to each end of the media ring, with one of the end caps having an annular body defining a central aperture sized so as to allow the support core to be inserted into and removed from the internal cavity of the element, and the retaining device is removably attached to the one end cap and projects radially inward into the internal cavity.

20. The filter assembly as in claim 19, wherein a groove is formed circumferentially around an inner wall surface of the aperture in the one end cap, and opens radially inward toward the central axis of the element, and the retaining device is received in the groove.

21. The filter assembly as in claim 20, wherein the one end cap includes an annular flange inwardly bounding the annulus of the one end cap, and projecting from an end connected to the body a short distance axially within the cavity toward the other end cap to a distal end located closer to the one end cap than the other, the groove formed in the flange toward the connected end of the flange.

22. The filter assembly as in claim 21, wherein the annular flange and annular body are formed unitary, in one piece.

23. The filter assembly as in claim 19, wherein the retaining device is a C-ring.

24. The filter assembly as in claim 19, wherein all components of the filter element are an incineratable material, and the support core is metal.

25. The filter assembly as in claim 19, wherein the support core is closely and completely received within the internal cavity of the filter media ring, and is supported at either end by the end caps of the element.

26. The filter assembly as in claim 25, wherein the retaining device is located so as to engage and support an axial end of the support core.

27. The filter assembly as in claim 26, wherein the support core is retained at another axial end by the other end cap.

28. The filter assembly as in claim 18, wherein the retaining device comprises means for retaining the support core in the filter element, and allowing removal thereof.

29. The filter assembly as in claim 18, wherein the housing includes an annular base, with a flow passage therein, supporting an end of the filter element.
